(19) United States
(12) Patent Application Publication
(10) Pub. No.: US 2009/0063508 A1
(43) Pub. Date: Mar. 5, 2009

(54) COMPUTER, SYSTEM, STORAGE AND ACCESS CONTROL METHOD, AND ACCESS CONTROL METHOD

(75) Inventors: Junichi YAMATO, Tokyo (JP); Yoshiaki SAKAE, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/197,705

(22) Filed: Aug. 25, 2008

(30) Foreign Application Priority Data
Aug. 27, 2007 (JP) 2007-220330

(51) Int. Cl. G06F 17/30

(52) U.S. Cl. 707/10; 707/E17.134

(57) ABSTRACT

A storage including an access processor configured to access data according to an access request specifying a file or a directory as an object of processing according to a content of a file handle cache held in a source of the request, further includes an access capability assigning unit configured to assign, when a file or a directory is made, an access capability serving as an identifier for uniquely identifying the file or the directory, and store the assigned access capability paired with a file handle for the file or the directory as metadata for the file or the directory and an access capability decision unit configured to decide, for the access request received by the access processor, whether the file handle specified as the object of processing of the access request is valid or invalid, based on a combination of the file handle and the access capability, wherein the access processor returns the access capability along with the file handle paired with the access capability according to a file handle acquisition request.

### CROSS-REFERENCE TO RELATED APPLICATIONS

This application is based upon and claims the benefit of priority from Japan patent application No. 2007-220330, filed on Aug. 27 2007, the disclosure of which is incorporated herein in its entirely by reference.

### BACKGROUND OF THE INVENTION

1. Field of the Invention

This invention relates to a computer system utilizing a storage, a storage, and an access control method and an access control program utilized in the computer system. More particularly, it relates to a computer system for caching a file handle??? in the host side, and a storage, an access control method, and an access control program utilized in the computer system.

2. Description of the Related Art

For a file-based storage such as NAS (Network Attached Storage), it is required that a pathname is resolved and information for accessing a file is acquired, in order to access data in the file.

As shown in Brent Callaghan “NFS Bible” Ascii Corporation, October 2001, P. 103-109, when resolving the pathname, information for accessing a directory is acquired in order of a layer of the directory, contained in the pathname, from the upper to the lower, and information for accessing the file is acquired. Information for accessing the file or directory is generally called as file handle (or file handler). The file handle is often cached at the host (device serving as source of an access request) since it causes poor efficiency if the host communicates with the storage every time the pathname is resolved. The word “caching” means memorization of information into a “cache memory” which means high-speed semiconductor memory or the like. The “caching” is realized by a speed-up technology such as transferring of a portion of data stored in a storage device such as hard disk where access speed is low, to a high-speed memory, that is, the “cache memory”. A file handle that is cached at the host is hereinafter called as “file handle cache”. The expression “cache” in some cases indicates information stored in an area on the cache memory using this technology, and in some cases indicates the area itself on the cache memory.

The file handle is, for example, an identifier for identifying a file or a directory in the storage device storing information of the file or the directory, and is stored in association with a pathname of the file or the directory. The identifier for identifying the file or the directory is, for example, an identifier directly attached to the file or the directory, an identifier directly attached to the metadata for the file or the directory, an indirect identifier for referring to the file or the directory, or an indirect identifier for referring to the metadata for the file or the directory. Here, “direct” indicates information which is capable of directly accessing to information of file or directory stored in a memory device in the storage, such as inode No. of Unix (registered trademark) file system or an object No. of OSD (object base storage device). Also “indirect” indicates information which is capable of accessing to information of corresponding file or directory based on the information (indirect identifier), although which is incapable of directly accessing to information of file or directory stored in a memory device in the storage, such as index No. of an array where metadata is stored or an address within the memory device.

The host may also serve as a file handle cache for storing not only the file handle, but also metadata accompanying file or directory corresponding to the file handle.

When a file or a directory is made, the file handle is assigned with a value of identifier corresponding to the file or the directory, and the value is unset when the file or the directory is deleted. The value of file handle, the name of file, and name of directory are therefore shared, by making or deleting of file or directory, so they sometimes indicate different file or directory even though the pathname or the value of file handle is the same.

In the case where the state of file system is multi-generation by snapshot or the like, a file directory which is in a different state may be indicated even if the pathname or the value of file handle is the same.

A first problem is that there is a possibility to access a file or a directory other than the targeted file or the targeted directory might be accessed in a file based storage. The reason is that because the same value of file handle, the same name of file or the same name of directory as previously used can be used again, the value of file handle, the name of file or name of directory is insufficient by itself for identifying a targeted file or a targeted directory.

A second problem is that a file or a directory other than the targeted file or the targeted directory might be accessed when the file handle cache is used. The reason is that the file handle cache is discarded according to time, and there is a possibility that the same value of file handle is assigned to different file or different directory due to the making or deleting of file or directory during a period before the file handle cache is discarded. Moreover, in multi-generation storage realized by snapshot or the like, because the file handle cache is not compatible with multi-generation, there is a possibility that an appropriate generation cannot be accessed.

A third problem is that the efficiency of file handle cache deteriorates when there is an attempt to reduce inconsistency between the file handle cache and information in the storage. The reason is that, since correction of inconsistency between the file handle cache and information in the storage is realized by the discard of the file handle cache according to the elapse of time, the time until the discard is shortened if there is an attempt to reduce inconsistency and the hit rate of cache is lowered since.

Japanese Patent Application Publication No. 2006-164169 discloses an NFS (Network File System), in which a method to discard the file handle cache (DNLC: Name of directory Lookup Cache) according to elapse of time is adopted. This method maintains the consistency between the file handle cache of the host side and information in the storage by reacquiring the file handle during the next access.

Regarding the consistency between the file handle cache of host side and the information in the storage, a method is disclosed in patent document 1 for making it unnecessary to resolve the name again even if the file system is migrated among servers, in NAS with cluster configuration. The method provides multi-version, but since the version is specified from the pathname, and it is not decide whether the path handle is correct or not. Therefore, under a circumstance where there is a possibility that different file can be indicated even if the pathname is the same as a result of share of the name of file, there is no guarantee of being able to correctly access a file that was linked to when the file handle was acquired.

### SUMMARY OF THE INVENTION

An exemplary object of the present invention is to improve access performance of the storage. More specifically, this invention has an exemplary object of reliably accessing a desired file or a desired directory without a drop in the hit rate of cache even in a storage where the value of file handle and the name of file or the name of directory are shared.

To achieve the above-described exemplary object, a storage according to an exemplary aspect of the invention includes an access processor configured to access data according to an access request specifying a file or a directory as an object of processing according to a content of a file handle cache held in a source of the request, further includes an access capability assigning unit configured to assign, when a file or a directory is made, an access capability serving as an identifier for uniquely identifying the file or the directory, and store the assigned access capability paired with a file handle for the file or the directory as metadata for the file or the directory, and an access capability decision unit configured to decide, for the access request received by the access processor, whether the file handle specified as the object of processing of the access request is valid or invalid, based on a combination of the file handle and the access capability, wherein the access processor returns the access capability along with the file handle paired with the access capability.

A computer system according to an exemplary aspect of the invention includes a host computer that operates according to a user program, and a storage that accesses data according to an access request specifying a file or a directory as an object of processing according to a content of a file handle cache held in the host computer, wherein the storage includes an access processor configured to receive the access request from the host computer, and access the data according to the received access request, an access capability assigning unit configured to assign, when a file or a directory is made, an access capability serving as an identifier for uniquely identifying the file or the directory, and store the assigned access capability paired with a file handle for the file or the directory as metadata for the file or directory, and an access capability decision unit configured to determining, for the access request received by the access processor, whether the file handle specified as the object of processing of the access request is valid or invalid, based on a combination of the file handle and the access capability, wherein the access processor returns the access capability along with the file handle paired with the access capability according to a file handle acquisition request, and wherein the host computer includes a storage device configured to store the file handle returned according to the file handle acquisition request as a pair with access capability, as the file handle cache, and a storage access unit configured to send an access request specifying information of the pair of the file handle and the access capability stored as the file handle cache, to the storage, as information for specifying the file or the directory as the object of processing.

The access control method according to an exemplary aspect of the invention is a method usable in a storage configured to access data according to an access request specifying a file or a directory as an object of processing according to a content of a file handle cache held in a source of the request, includes a step for assigning, when a file or a directory is made, an access capability serving as an identifier for uniquely identifying the file or the directory, and storing the assigned access capability paired with a file handle for the file or the directory as metadata for the file or the directory, a step for returning the access capability along with the file handle paired with the access capability according to the file handle acquisition request, a step for deciding, for the received access request, whether the file handle specified as the object of processing of the access request is valid or invalid, based on a combination of the file handle and the access capability, and a step for accessing data according to the access request when it is decided that the file handle specified as the object of processing is valid.

A control program for a storage according to an exemplary aspect of the invention is a program usable in a storage configured to access data according to an access request specifying a file or a directory as an object for processing according to a content of a file handle cache held in a source of the request, including:

a process for assigning, when a file or a directory is made, an access capability serving as an identifier for uniquely identifying the file or the directory, and storing the assigned access capability paired with a file handle for the file or the directory as metadata for the file or the directory;

a process for returning the access capability along with the file handle paired with the access capability according to the file handle acquisition request;

a process for deciding, for the received access request, whether the file handle specified as the object of processing of the access request is valid or invalid, based on a combination of the file handle and the access capability; and

a process for accessing data according to the access request when it is decided that the file handle specified as the object of processing is valid.

This invention is capable of improving the storage accessing performance.

### BRIEF DESCRIPTION OF THE DRAWINGS

FIG. 1 is a block diagram showing an example of a structure of storage according to a first exemplary embodiment;

FIG. 2 is a block diagram showing more specific example of a structure of computer system including storage according to a first exemplary embodiment;

FIG. 3 is an explanatory diagram showing an example of information stored in file handle cache 201;

FIG. 4 is an explanatory diagram showing another example of information stored in file handle cache 201;

FIG. 5 is an explanatory diagram showing an example of metadata for directory held in the storage;

FIG. 6 is an explanatory diagram showing an example of metadata for file held in the storage;

FIG. 7 is a flow chart showing an example of operation of pathname resolution processing in storage access unit 20 according to a first exemplary embodiment;

FIG. 8 is a flow chart showing another example of operation in processing of pathname resolution in storage access unit 20 according to a first exemplary embodiment;

FIG. 9 is a flow chart showing another example of operation in processing of pathname resolution in storage access unit 20 according to a first exemplary embodiment;

FIG. 10 is a flow chart showing an example of operation when storage 1 receives a file handle acquisition request;

FIG. 11 is a flow chart showing another example of operation when storage 1 receives a file handle acquisition request;

FIG. 12 is a flow chart showing an example of operation when storage 1 receives a file making request;

FIG. 13 is a flow chart showing another example of operation when storage 1 receives a file making request;

FIG. 14 is a flow chart showing an example of operation when storage 1 receives a directory making request;

FIG. 15 is a flow chart showing another example of operation when storage 1 receives a directory making request;

FIG. 16 is a flow chart showing an example of operation when storage 1 receives a metadata processing request;

FIG. 17 is a flow chart showing another example of operation when storage 1 receives a metadata processing request;

FIG. 18 is a block diagram showing an example of a structure of computer system including storage according to a second exemplary embodiment;

FIG. 19 is a flow chart showing an example of operation of storage 1, when a new generation is made, according to a third exemplary embodiment:

FIG. 20 is an explanatory diagram showing an example of metadata for directory held in storage according to a third exemplary embodiment;

FIG. 21 is an explanatory diagram showing an example of metadata for file held in storage according to a third exemplary embodiment;

FIG. 22 is a flow chart showing an example of operation of storage 1, when a request from host 2 is received, according to a third exemplary embodiment.

### DETAILED DESCRIPTION OF EXEMPLARY EMBODIMENTS OF THE INVENTION

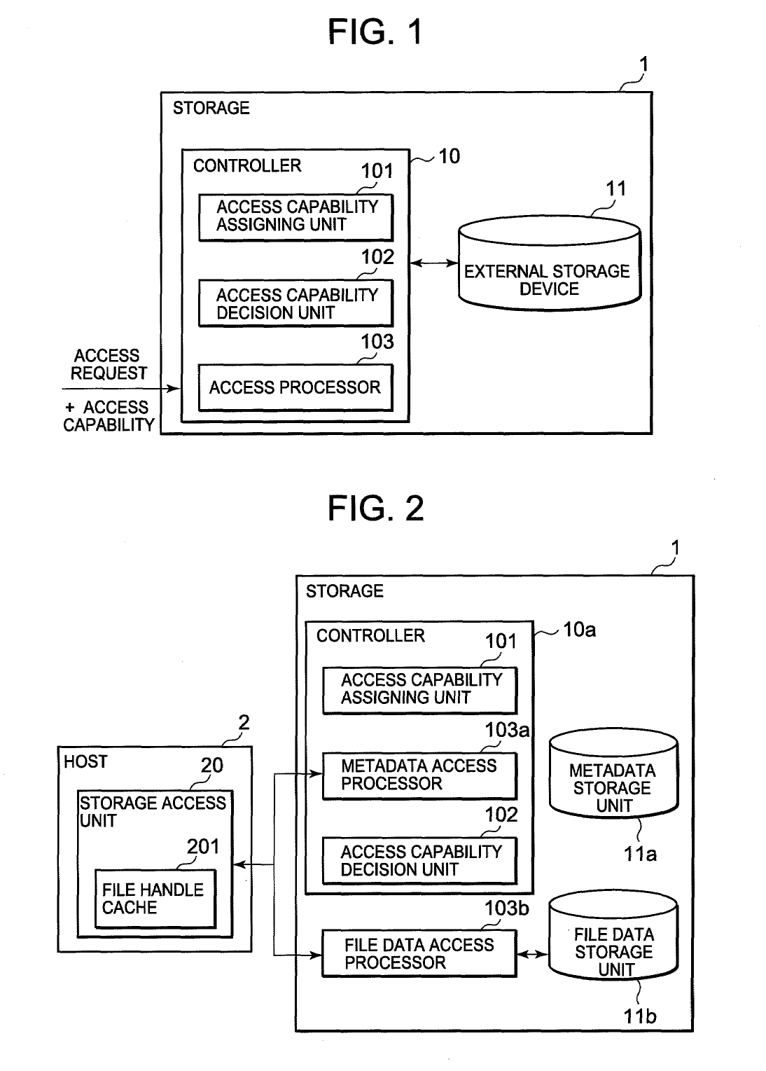

Hereinafter, a first exemplary embodiment is described with reference to the drawings. FIG. 1 is a block diagram showing an example of a structure of storage according to this exemplary embodiment. Storage 1 shown in FIG. 1 includes an external storage device 11 such as a hard disk (magnetic disk), floppy (registered trademark) disk, MO, CD-R, magnetic tape and so on, and a controller 10 that controls the external storage device 11. The external storage device 11 may be an assembled device including some or any of a hard disk (magnetic disk), floppy (registered trademark) disk, MO, CD-R, magnetic tape array, library and so on. The controller 10 is realized by, for example, a CPU or computer (server device) that operates according to a program.

An access capability assigning unit 101 assigns an identifier by which making of a file or a directory can uniquely be identified. An identifier assigned by the access capability assigning unit 101 is hereafter called as “access capability”. For example, the access capability assigning unit 101 assigns an access capability, when a file or a directory is made, and stores the access capability as metadata for the file or the directory. Even if a pathname or a value of file handle is identical with a previous file or a previous directory, the access capability which was assigned to the previous file or the previous is not assigned. The detailed process of assignment of the access capability by the assigning unit 101 is described later.

In this exemplary embodiment, the host is also notified of the access capability, and the file handle and the access capability are cached, as the file handle cache, in a pair.

According to an access request from the host, an access capability decision unit 102 decides whether or not the access request is capable, based on the file handle and the access capability attached for specifying the directory or the file targeted by the access request. More specifically, if the value of the file handle and the value of access capability specified by the host are not identical with the value of the file handle and the value of access held in the storage, then the access capability decision unit 102 determines the file handle cache held by the host is invalid and the access request is incapable. In this exemplary embodiment, “access request” is not limited to “read” or “write” requests to the storage 1, but is used as an expression indicating all of the processing requests to the storage 1 from the host, including such as pathname resolution (file handle acquisition) or acquisition of access authority.

An access processor 103 performs an actual processing for the access request from the host. In this exemplary embodiment, the access processor 103 performs the processing for the access request that is determined as incapable by the access capability decision unit 102. For the access request that is determined as incapable by the access capability decision unit 102, information indicating that the file handle cache is invalid is returned. On the host side, upon receipt of the notification indicating that the file handle cache is invalid, the file handle cache may be deleted.

FIG. 2 is a block diagram showing more specific example of a structure of computer system including storage according to this exemplary embodiment. The computer system shown in FIG. 2, includes host 2, where a user program operates, and storage 1, where data is stored. The host 2 and the storage 1 are connected by a network such as Ethernet (registered trademark).

The host 2 is a computer operated by a user program (not shown), and includes storage access unit 20. The storage access unit 20 includes file handle cache 201 which caches the file handle held in the storage 1. More specifically, the user program operates by the operation of CPU contained in the host 2 according to the user program. The user program performs a variety of processing for a file or a directory stored in the storage 1 via the storage access unit 20. The file handle cache 201 is a memory device which caches the file handles. This memory device may be either volatile or nonvolatile.

The storage 1 is a memory device (including a controller that controls the memory device) such as NAS (Network Attached Storage) that stores a file, and includes metadata management unit 10a, access processor 10b, metadata storage unit 11a, and file data storage unit 11b. The metadata management unit 10a includes an access capability assigning unit 101, an access capability decision unit 102, and metadata access processor 103a.

The metadata management unit 10a performs processing relating to the metadata stored in the metadata storage unit 11a. Here, metadata means attribute information of a directory or a file managed in the storage 1, and includes, for example, not only information relating to access authority to the file or the directory or information relating to an owner, but also the file handle for accessing the file or the directory. In this exemplary embodiment, metadata also includes an access capability assigned by the access capability decision unit 102. The metadata storage unit 11a is a nonvolatile storage medium that stores metadata.

The access capability assigning unit 101 and the access capability decision unit 102 are as described above. In this exemplary embodiment, an access capability assigned by the access capability assigning unit 101 is paired with a file handle, and stored as metadata in the metadata storage unit 11a. According to an access request from the host, the access capability decision unit 102 searches, in the metadata storage unit 11a, for information of file or directory identical with the value of access capability and the value of file handle attached to specify the file or the directory as an object of the access request. If there is no file information or directory identical with the value of access capability and the value of file handle, then the access capability decision unit 102 decides that the file handle cache held by the host is invalid.

The metadata access processor 103a performs access processing (for example, acquisition processing of file handle or acquisition processing of access authority) for metadata. The metadata access processor 103a is a processor which performs processing for an access request to metadata, among the processing by the access processor 103 shown in FIG. 1.

File data access processor 103b performs access processing (for example, read/write 15 processing) for file data. The file data access processor 103b is a processor which performs processing for an access request to file data, among the processing by the access processor 103 shown in FIG. 1. Here, the term “file data” means information stored as a file, in other words, means data which is the content of file. The file data storage unit 11b is a nonvolatile storage medium which stores file data. The file storage unit 11a and the metadata storage unit 11b may be realized by the same device.

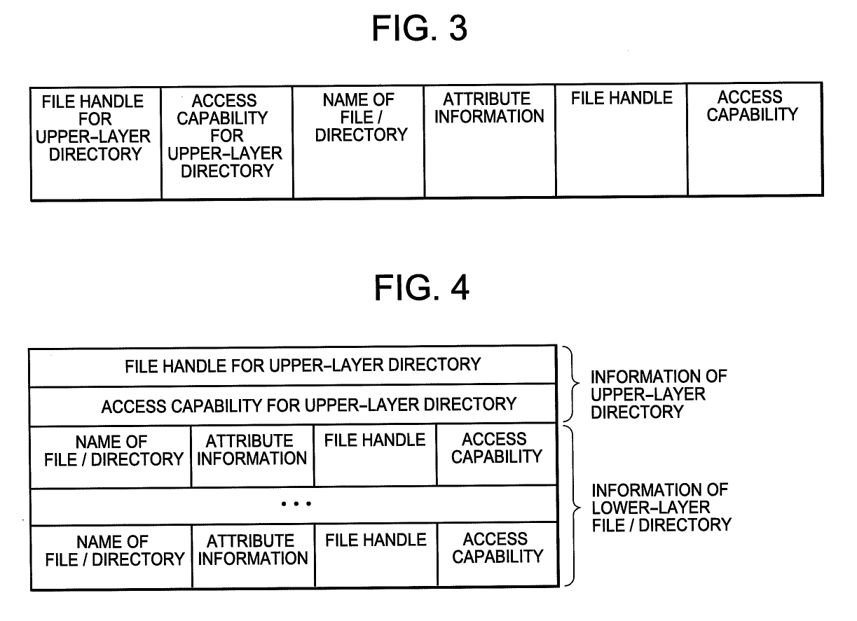

FIG. 3 is an explanatory diagram showing an example of information (Hereinafter, called as “cache entry”.) stored in the file handle cache 201. As shown in FIG. 3, in each cache entry of file handle cache 201, a file handle and an access capability for the upper-layer directory, the name of targeted file or targeted directory, a file handle and an access capability for the file or the directory, or attribute information including information such as access authority or an owner or access, may be stored. As shown in FIG. 4, each file handle cache entry may be organized according to file handle for its upper-layer directory. In FIG. 1, as an example, only one unit of host 2 is shown, but this exemplary embodiment can be realized with multiple units of host 2.

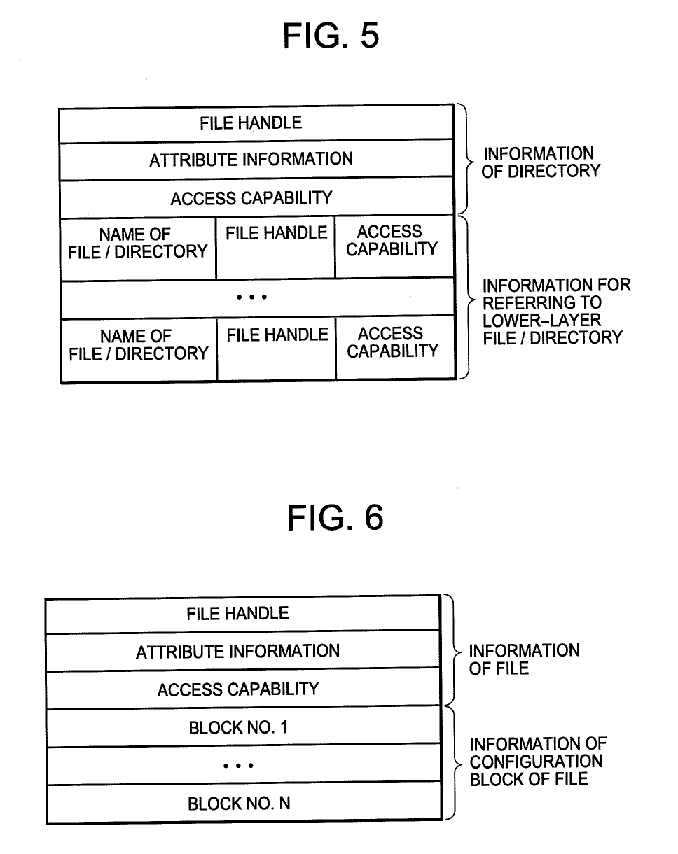

FIG. 5 is an explanatory diagram showing an example of metadata for directory stored in the storage. As shown in FIG. 5, the metadata for directory may include information (file handle) for accessing the directory, attribute information for the directory, an access capability, or information for referring to each individual element of a group of lower-layer elements (files or directories). As information for referring to the lower-layer element, for example, information combining the file handle and the access capability for the lower-layer directory or file may for be utilized. The name of the file or the directory may also be included.

FIG. 6 is an explanatory diagram showing an example of metadata for a file stored in the storage. As shown in FIG. 6, the metadata for a file may include information (file handle) for accessing the file, attribute information for the file or an access capability. When the file is stored in a block configuration, the metadata for the file may include information of a configuration block of the file (for example, block No.).

Hereinafter, the operation of this exemplary embodiment is described.

First, pathname resolution is described. The pathname resolution is a processing by which the host acquires information for accessing a file or a directory at the terminal of the pathname expressed in such a format as “/foo0/foo1/foo2/foo3”. In this exemplary embodiment, pathname resolution is a processing for acquiring at least the file handle and the access capability. In this exemplary embodiment, “/” is used as a delimiter for a file or a directory in the pathname, but “\” or other character may be used. AS to the lead directory, called as “root”, the file handle and the access capability is to be acquired during the operation (called as “mount”) for using the file system.

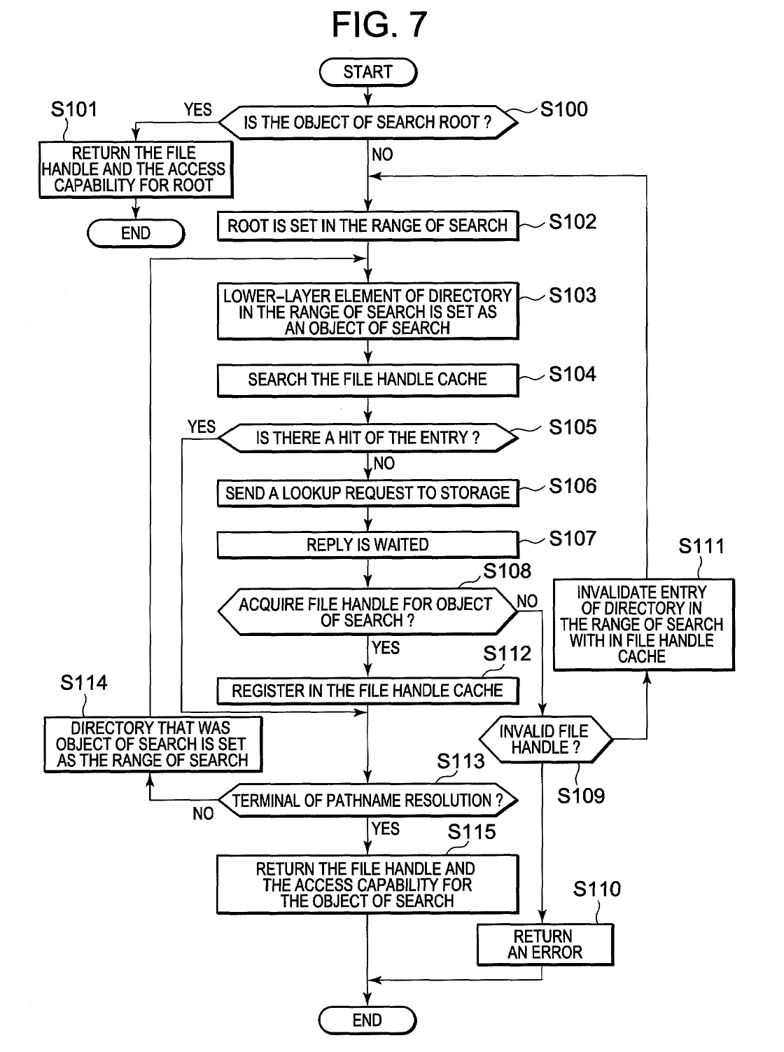

FIG. 7 is a flow chart showing an example of the operation of the pathname resolution processing in the storage access unit 20 according to this exemplary embodiment. As shown in FIG. 7, first, the storage access unit 20 determines whether the pathname to be resolved (for example, the object. of search) is a root (“/”) or not, and, if it is a root, then the process shifts to step S101, otherwise the process shifts to S102 (step S100).

In step S101, the file handle and access capability etc. corresponding to root are returned and the process ends.

On the other hand, in step S102, the root is set as the directory in the range of search. Next, a lower-layer element (directory or file), according to the pathname to be resolved, of the directory in the range of search is set as an object of search (step S103). In file handle cache, an entry, of which upper-layer is the directory in the range of search, and which registers an element being the object of search as lower-layer directory or file, is searched (step S104). If an appropriate entry exists in the file handle cache, then the process shifts to step S130, otherwise the process shifts to step S106 (step S105).

In step S106, the storage access unit 20 sends, to the storage 1, a file handle acquisition request (lookup request) for a directory or a file being the object of search within the directory in the range of search. The file handle acquisition request includes, as information specifying the file handle desired to acquire, a file handle and an access capability for the upper-layer directory, and the name of a directory or a file being an object of acquisition. As the file handle and the access capability for the upper-layer directory, the file handle and the access capability for the directory in the range of search in process, may be set. Also, as the name of the directory or the file being the object of acquisition, the name of the file or the directory being the object for search in process, may be set.

Then, a reply from the storage 1 is waited for (step S107), and, if a file handle is acquired from storage 1, then the process shifts to step S112, otherwise the process shifts to step S109 (step S108).

In step S109, the storage access unit 20 shifts its process according to the reason that the file handle could not be acquired from storage 1. If the reason is that the specified file handle is invalid then the process shifts to step S111, otherwise an error is returned and the process ends (step S110).

If the reason is that the specified file handle is invalid, i.e. in step S111, the storage access unit 20 invalidates an entry related to the directory in the range of search within the file handle cache. More specifically, along with invalidating an entry where the access capability and the file handle for the directory in the range of search are registered as information of upper-layer directory, the storage access unit 20 invalidates the information indicating the directory in the range of search as the lower-layer directory in the entry where the directory in the range of search is registered as a lower-layer directory. Next, returning to step S102, the directory in the range of search is set as the root again and the process is reset.

If the file handle is acquired from storage 1, then the storage, i.e. in step 112, the access unit 20 registers, as cache entry for the directory or file being the object of search, at least the file handle and the access capability acquired from storage 1, associated with the name of directory or file being the object of search, in the file handle cache. When the cache entry for the directory or the file being the object of the search is registered, the file handle and the access capability for the directory in the range of the search may be included as the information of the upper-layer directory. If other information (for example, attribute information) is acquired from the storage 1, then it may be registered together.

After the cache entry is registered, or when the cache entry that is the object of the search is hit in step S105, it is checked whether the directory or the file for which file handle is acquired (in other words, the element being the object of search in process) is the terminal of the pathname to be resolved. If it is the terminal of the pathname, then the process shifts to step S115, otherwise the process shifts to step S114.

In step S114, the directory (here, should be “directory” because it is not terminal.) being the object of search directory that acquired the file handle is set as a new directory in the range of the search. The process then returns to step S103, and with the lower-layer element of the directory in the range of the search as the object of search, an attempt is made to acquire a file handle for the element being the object of search with the acquired pathname, based on the newly set directory in the range of the search.

On the other hand, in step 115, the file handle and the access capability for the directory or the file being the terminal of the pathname to be resolved (In other words, the element being the object of the search in process) are returned and the process ends. Other information (for example, attribute information) registered in the cache entry may be returned along with the file handle and the access capability.

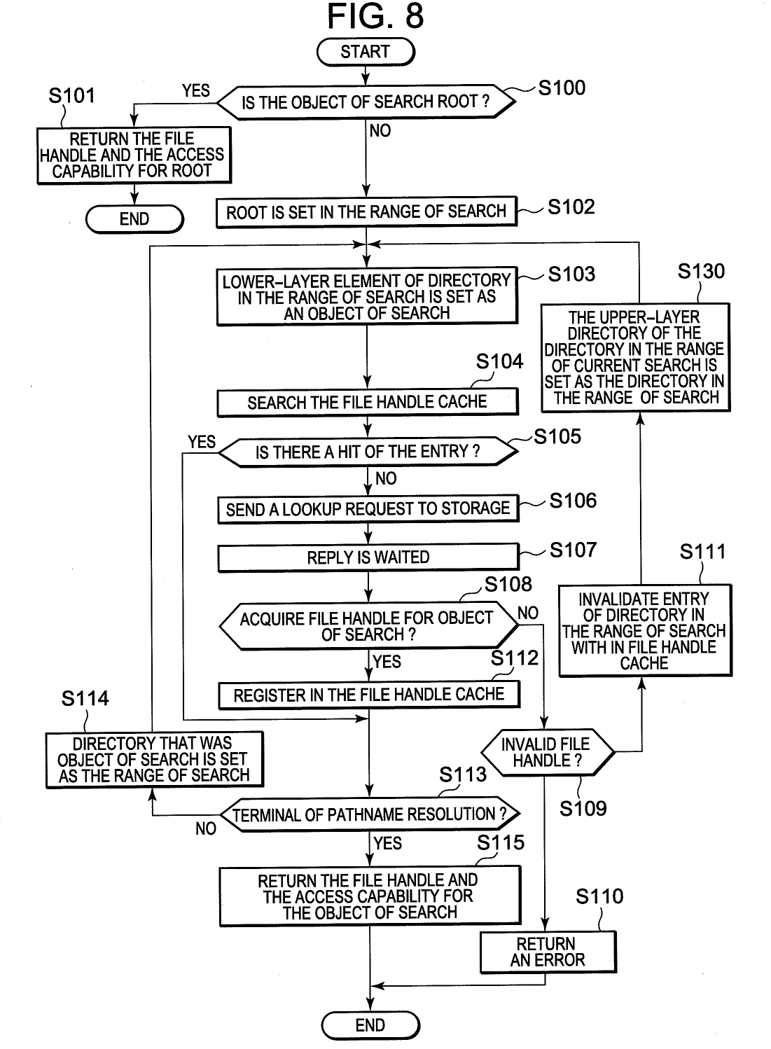

In the above described operation, after step S111, the process is re-performed from the root, if the reason is that the specified file handle (i.e. the file handle for the directory in the range of the search) is invalid. However, if a result of the search in the file handle cache for the directory in the range of the prior search is recorded, then the process can be restarted from the next upper-layer directory. In this case, as shown in FIG. 8, the upper-layer directory of the directory in the range of the search may be set as the directory in the range of the search, and the process can return to step S103 (step S130).

In this way, the load of processing re-performed in a case where the file handle is invalid can be reduced, and improvement of response and alleviation of the load on host 2 can be realized.

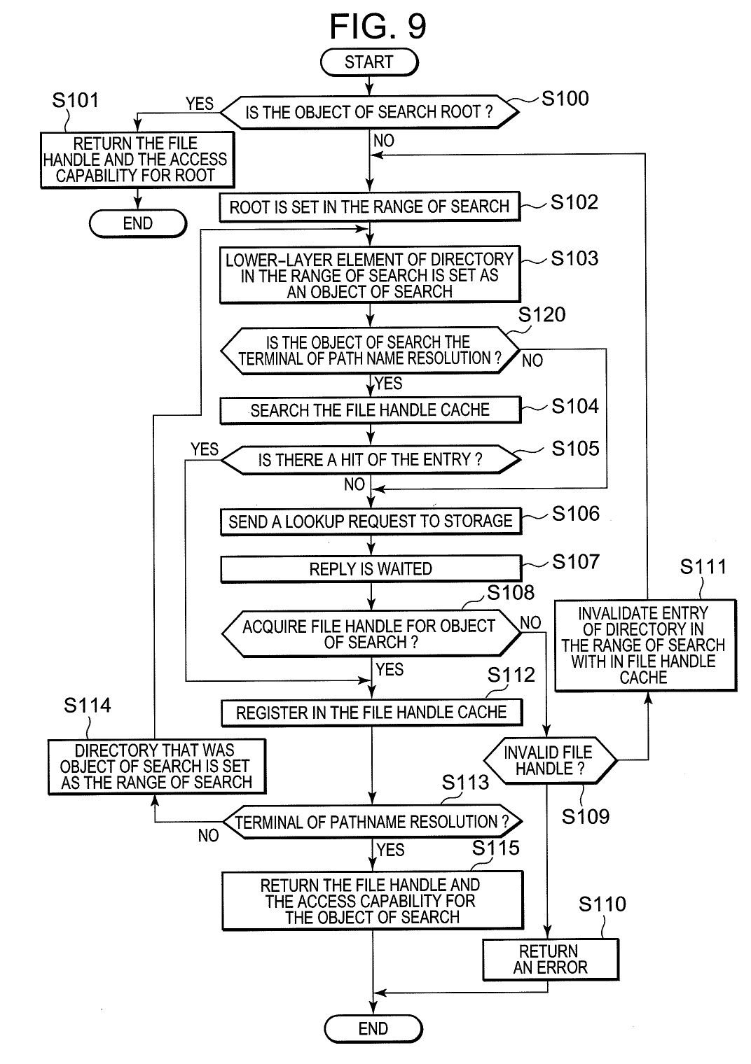

Some of NFS is configured to interrogate the storage 1 about the directory or the file as the terminal. In such cases, as shown in FIG. 9, between steps S103 and S104, it may be determined whether or not the object of the search is the terminal of the pathname to be resolved, and, if it is the terminal of the pathname, the process may shift to step S106. In this way, the latest file handle, access capability and attribute information for the directory or the file as the terminal can be obtained.

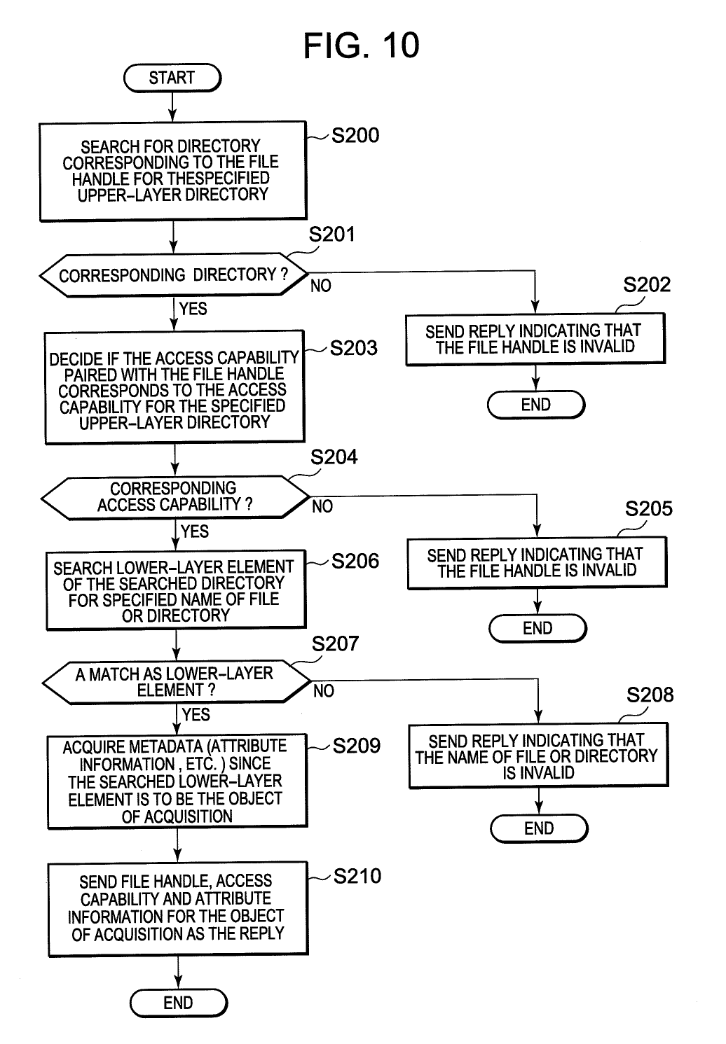

FIG. 10 is a flow chart showing an example of the operation when storage 1 receives the file handle acquisition request (lookup request). In this exemplary embodiment, the file handle acquisition request includes the access capability and the file handle for the upper-layer directory and the name of the directory or file being the object of acquisition, as information specifying the file handle to be acquired. The file handle acquisition request is processed by the metadata access processor 103a of metadata management unit 10a in storage 1.

As shown in FIG. 10, when the metadata access processor 103a receives the file handle acquisition specifying the access capability and the file handle for the upper-layer directory and the name of the file or directory that is the object of acquisition from host 2, a directory corresponding to the file handle for the specified upper-layer directory, is searched in the metadata storage unit 11 (step S200).

If there is no corresponding directory then the process shifts to step S202, and if there is a corresponding directory then the process shifts to step S203 (step S201). In step S202, a reply, indicating that the file handle is invalid, is returned (sent to host 2 that is the source of request), and the process ends.

On the other hand, if information of the directory (metadata) corresponding to the file handle for the upper-layer directory is stored in the metadata storage unit 11a, i.e. in step S203, the access capability decision unit 102 decides, within the metadata for the directory in the metadata storage unit 11a acquired in step S200, whether or not the access capability paired with the file handle for the directory corresponds to the access capability for the specified upper-layer directory. If there is a corresponding access capability then the process shifts to step S206, and if there is no corresponding access capability, then the process shifts to step S205 (step S204).

If there is no corresponding access capability, i.e. in step S205, the file handle acquisition request is not to be capable, and the metadata access processor 103a returns a reply indicating that the file handle is invalid, and the process ends. For example, when the file handle for the upper-layer directory is searched in the metadata storage unit 10a, the metadata access processor 103a may notify the access capability decision unit 102 of the file handle and information of the specified upper-layer directory and inquire whether the request is to be capable or not. Then, according to the response to the inquiry from the access capability decision unit 102, a reply indicating that the file handle is invalid may be returned.

On the other hand, when there is a corresponding access capability, i.e. in step S206, the file handle acquisition request is to be capable, and the metadata access processor 103a searches for a match for the name of directory or file specified as the object of acquisition in the lower-layer element group (directory-file group) of the upper-layer directory, based on information of the upper-layer directory acquired in step S200. Here, if there is no match then the process shifts to step S208, and if there is a match then the process shifts to step S209 (step S207).

If there is no match for the name of file or directory specified as the object of acquisition in the lower-layer element group of the upper-layer directory, i.e. in step S208, then a reply indicating that the name of file or directory is invalid is returned and the process ends.

On the other hand, if there is a match for the name of the file or directory specified as the object of acquisition in the lower-layer element group of the upper-layer directory, i.e. in step S209, metadata for the directory or the file corresponding to the file handle and the access capability for the element (i.e. the directory or the file being the object of acquisition) is searched in the metadata storage unit 10a, based on information of the lower-layer element corresponding to the name of the file or directory being the object of acquisition that is searched in step S206, and attribute information of the directory or the file is acquired.

A reply, including the file handle and the access capability for the file or the directory that is the object of acquisition that is searched in step S206 or S209 and the attribute information is returned (step S210), and the process ends.

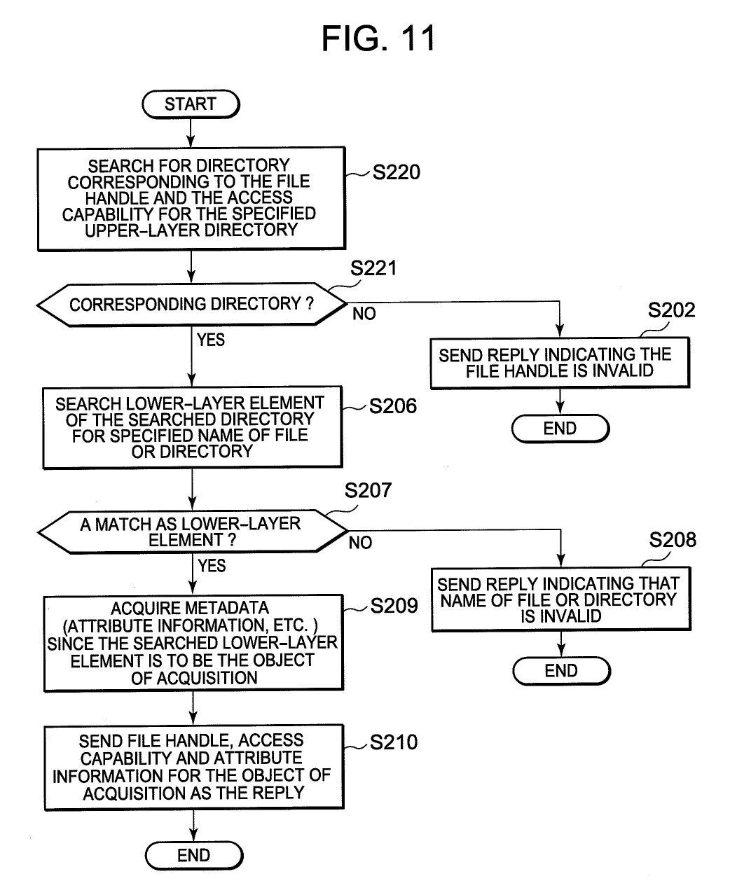

In the above operation, as an example, the value of the file handle and the value of access capability are judged separately, but these values can be judged together. As shown in FIG. 11, for example, a match for both of the file handle for the upper-layer directory and the access capability for the upper-layer directory may be searched in metadata storage unit 10a (step S220). For example, the metadata access processor 103 may notify the access capability decision unit 102 of the received file handle acquisition request, and inquire whether the request is to be capable or not, and if there is a match as a result of the processing in step S220, the access capability decision unit 102 may return the response to the inquiry, indicating the file handle acquisition request is capable, along with the file handle for the upper-layer directory. Since the operation in and after step S221 is identical to the operation in and after step S204 in FIG. 10, the description is omitted.

Other requests from the host 2 to the storage 1 after the resolution of the pathname are described next. For each request other than the file handle acquisition request, the file handle and the access capability for the file or the directory that is the object of processing are to be acquired in advance by the operation of pathname resolution.

The operation concerning a file making request is described first. In this exemplary embodiment, when there is a request for making a file, the storage access unit 20 of host 2 sends a file making request, specifying the file handle and the access capability for the upper-layer, the name of the file to be made and so on (name of file, attribute, etc.), to storage 1.

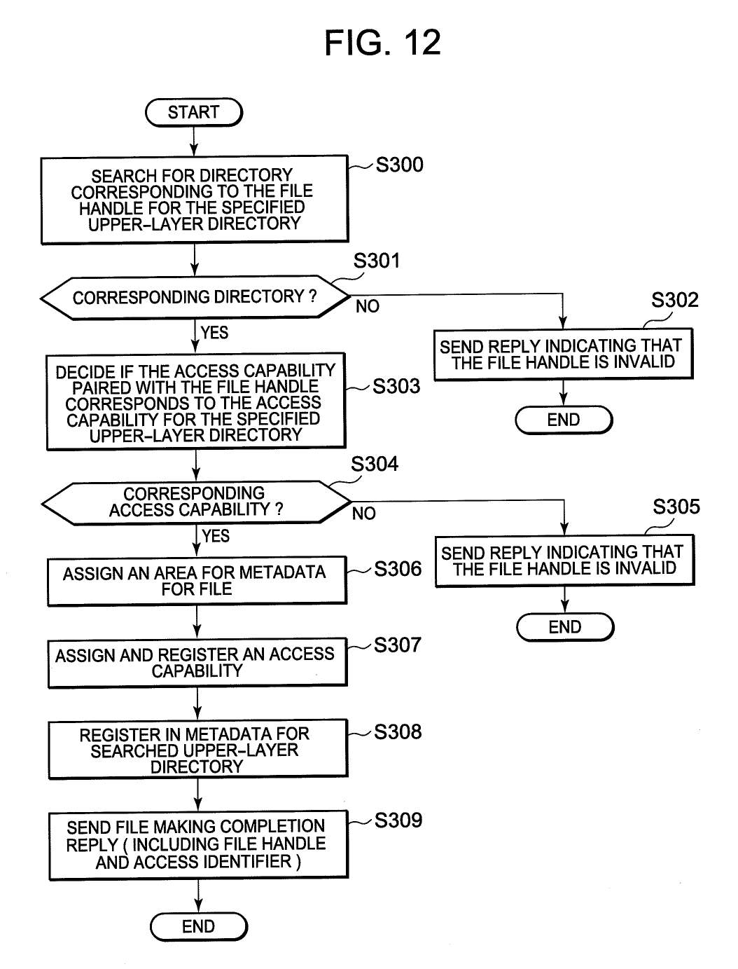

FIG. 12 is a flow chart showing an example of the operation when storage 1 receives a file making request. In this example, the metadata access processor 103a of metadata management unit 10a processes the file making request.

As shown in FIG. 12, when the metadata access processor 103a receives a file making request, specifying the file handle and access capability for the upper-layer directory, the name of the file to be made and so on, from host 2, a directory corresponding to the file handle for the specified upper-layer directory, is searched in the metadata storage unit 11a (step S300).

If there is no corresponding directory then the process shifts to step S302, and if there is a corresponding directory then the process shifts to step S303 (step S301). In step S302, a reply, indicating that the file handle is invalid, is returned (sent to host 2 as the source of request), and the process ends.

On the other hand, if information of the directory (metadata) corresponding to the file handle for the upper-layer directory is stored in the metadata storage unit 11a, i.e. in step S303, the access capability unit 102 determines, within the metadata for the directory in the metadata storage unit 11a acquired in step S300, whether or not the access capability paired with the file handle for the directory corresponds to the access capability for the specified upper-layer directory. If there is a corresponding access capability then the process shifts to step S306, and if there is no corresponding access capability then the process shifts to step S305 (step S304).

If there is no corresponding access capability, i.e. in step S305, the file making request is not to be capable, and the metadata access processor 103a returns a reply indicating that the file handle is invalid, and the process ends. For example, when the file handle for upper-layer directory is searched in the metadata storage unit 10a, the metadata access processor 103a may notify the access capability decision unit 102 of the file handle and information of the specified upper-layer directory and inquire whether the request is to be capable or not. Then, according to the response to the inquiry from the access capability decision unit 102, a reply indicating that the file handle is invalid may be returned.

On the other hand, when there is a corresponding access capability, i.e. in step S306, the file making request is to be capable, and the metadata access processor 103a starts the processing to make the specified file. More specifically, the metadata access processor 103a performs an assignment of file handle and an initialization of metadata. At this point (at time of making the file) the metadata access processor 103a assigns a file handle to be uniquely identifiable for the file in the storage 1, and retains (assigns) an area for storing metadata for the file for storing the file handle in the metadata storage unit 10a. Then, initialization, such as registering the value of the assigned file handle, registering name of the file, and registering the file handle and the access capability for the upper-layer directory into the assigned area for storing metadata for the file, may be performed.

Next, the access capability assigning unit 101 assigns an access capability paired with the file handle assigned in step S306 (step S307). This assigned access capability is registered into metadata for the file in the metadata storage unit 10a, which is retained in step S306. When the access capability assigning unit 101 assigns an access capability, the metadata access processor 103a registers information of the file as the information on the lower-layer element included in the metadata for the upper-layer directory of the made file (step S308). Then, a file making completion reply that includes the assigned file handle and access capability is returned (step S309), and the process ends.

If a reply other than the file making completion reply is returned from storage 1, then the storage access unit 20 of host 2 may end the processing as an error (after returning a message indicating that the making of file fails). If a reply indicating that the specified file handle is invalid is returned from storage 1, then the storage access unit 20 may re-perform the process from the pathname resolution.

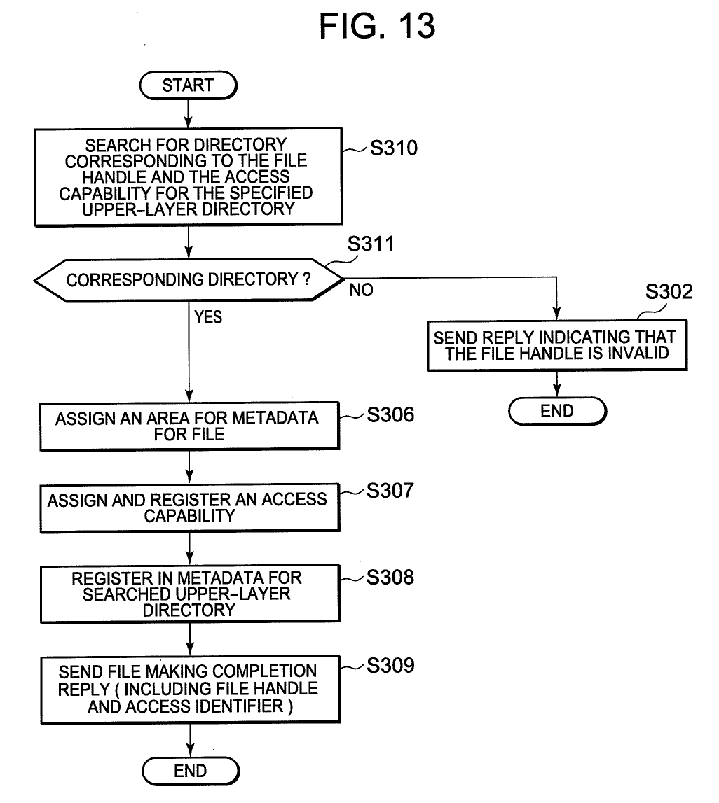

The value of file handle and the value of access capability can be judged together even in the operation when the file making request is received. As shown in FIG. 13, for example, a match for both the file handle for the upper-layer directory and the access capability for the upper-layer directory may be searched in metadata storage unit 10a (step S310). For example, the metadata access processor 103 may notify the access capability decision unit 102 of the received file making request, and inquire whether the request is to be capable or not, and if there is a match as a result of the processing in step S310, the access capability decision unit 102 may return the response to the inquiry, indicating the file making request is capable, along with the file handle for the upper-layer directory. Since the operation in and after step S311 is identical to the operation in and after step S304 in FIG. 12, the description is omitted.

The operation concerning a directory making request is described next. In this exemplary embodiment, when there is a request for making a directory, the storage access unit 20 of host 2 sends a directory making request, specifying the file handle and the access capability for the upper-layer, the name of the directory to be made and so on (name of directory, attribute, etc.), to storage 1.

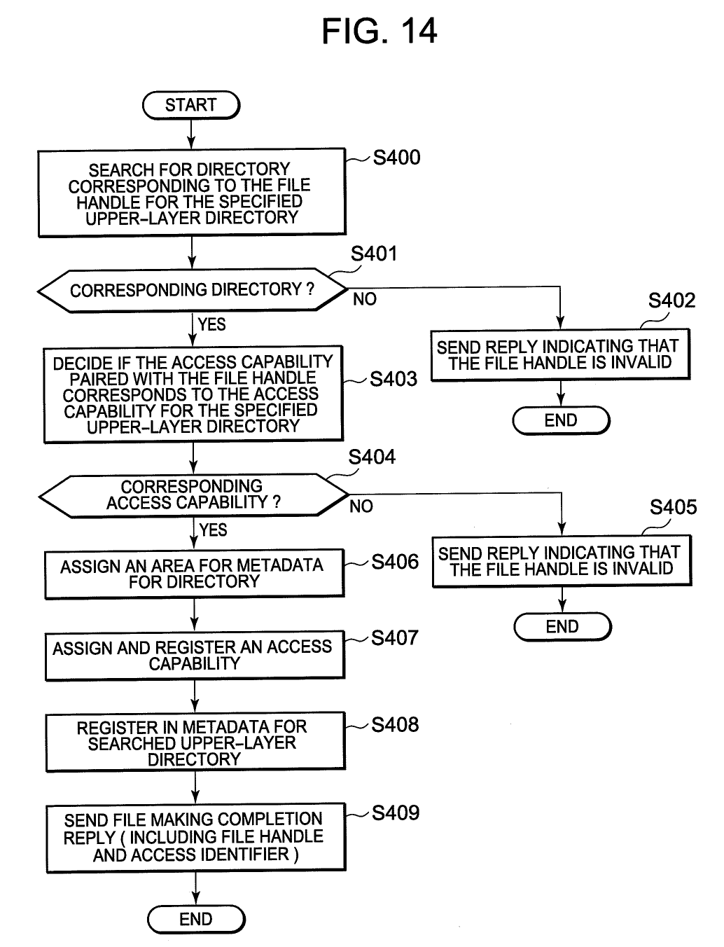

FIG. 14 is a flow chart showing an example of the operation when storage 1 receives a directory making request. In this example, the metadata access processor 103a of metadata management unit 10a processes the directory making request.

As shown in FIG. 14, when the metadata access processor 103a receives a directory making request, specifying the file handle and the access capability for the upper-layer directory, the name of directory to be made and so on, from host 2, a directory corresponding to the file handle for the specified upper-layer directory, is searched in the metadata storage unit 11a (step S400).

If there is no corresponding directory then the process shifts to step S402, and if there is a corresponding directory then the process shifts to step S403 (step S401). In step S402, a reply indicating the file handle is invalid is returned (sent to host 2 being the source of request), and the process ends.

On the other hand, if information of the directory corresponding to the file handle for the upper-layer directory is stored in the metadata storage unit 11a, i.e. in step S403, the access capability decision unit 102 determines, within the metadata for the directory in the metadata storage unit 11a acquired in step S400, whether or not the access capability paired with the file handle for the directory corresponds to the access capability for the specified upper-layer directory. If there is a corresponding access capability then the process shifts to step S406, and if there is no corresponding access capability then the process shifts to step S405 (step S404).

If there is no corresponding access capability, i.e. in step S405, the directory making request is not to be capable, and the metadata access processor 103a returns a reply indicating that the file handle is invalid, and the process ends. For example, when the file handle for upper-layer directory is searched in the metadata storage unit 10a, the metadata access processor 103a may notify the access capability decision unit 102 of the file handle and information of the specified upper-layer directory and inquire whether the request is to be capable or not. Then, according to the response to the inquiry from the access capability decision unit 102, a reply indicating that the file handle is invalid may be returned.

On the other hand, when there is a corresponding access capability, i.e. in step S406, the directory making request is to be capable, and the metadata access processor 103a starts the processing to make the specified directory. More specifically, the metadata access processor 103a performs an assignment of file handle and an initialization of metadata. At this point (at time of making the directory) the metadata access processor 103a assigns a file handle to be uniquely identifiable for the directory in the storage 1, and retains (assigns) an area for storing metadata for the directory for storing the file handle in the metadata storage unit 10a. Then, initialization, such as registering the value of the assigned file handle, registering name of the directory, and registering the file handle and the access capability for the upper-layer directory into the assigned area for storing metadata for the directory, may be performed.

Next, the access capability assigning unit 101 assigns an access capability paired with the file handle assigned in step S406 (step S407). This assigned access capability is registered into metadata for the directory in the metadata storage unit 10a, which is retained in step S406. When the access capability assigning unit 101 assigns an access capability, the metadata access processor 103a registers information of the directory as the information on the lower-layer element included in the metadata for the upper-layer directory of the made directory (step S408). Then, a directory making completion reply that includes the assigned file handle and access capability is returned (step S409), and the process ends.

If a reply other than the directory making completion reply is returned from storage 1, then the storage access unit 20 of host 2 may end the processing as an error (after returning a message indicating that the making of directory fails). If a reply indicating that the specified file handle is invalid is returned from storage 1, then the storage access unit 20 may re-perform the process from the pathname resolution.

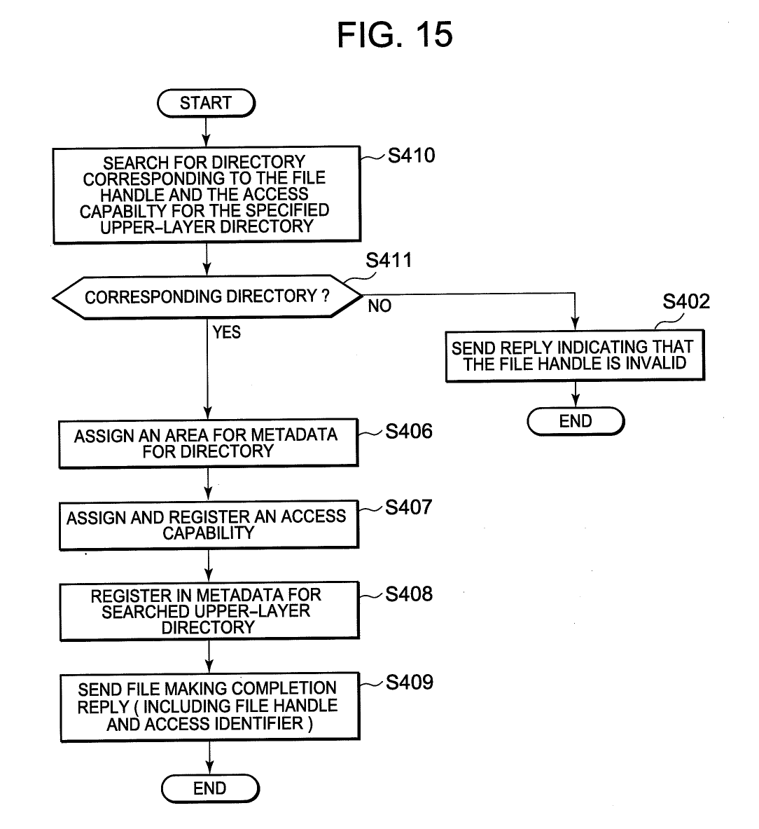

The value of file handle and the value of access capability can be judged together even in the operation when the directory making request is received. As shown in FIG. 15, for example, a match for both the file handle for the upper-layer directory and the access capability for the upper-layer directory may be searched in metadata storage unit 10a (step S410). For example, the metadata access processor 103 may notify the access capability decision unit 102 of the received directory making request, and inquire whether the request is to be capable or not, and if there is a match as a result of the processing in step S410, the access capability decision unit 102 may return the response to the inquiry, indicating the directory making request is capable, along with the file handle for the upper-layer directory. Since the operation in and after step S411 is identical to the operation in and after step S404 in FIG. 14, the description is omitted.

The operation concerning a processing request relating to metadata for a file or a directory is described next. In this exemplary embodiment, when there is a request for processing of metadata for a file or a directory, the storage access unit 20 of host 2 sends a metadata processing request, specifying the file handle and the access capability for the file or the directory being the object and parameter indicating the content of processing, to storage 1.

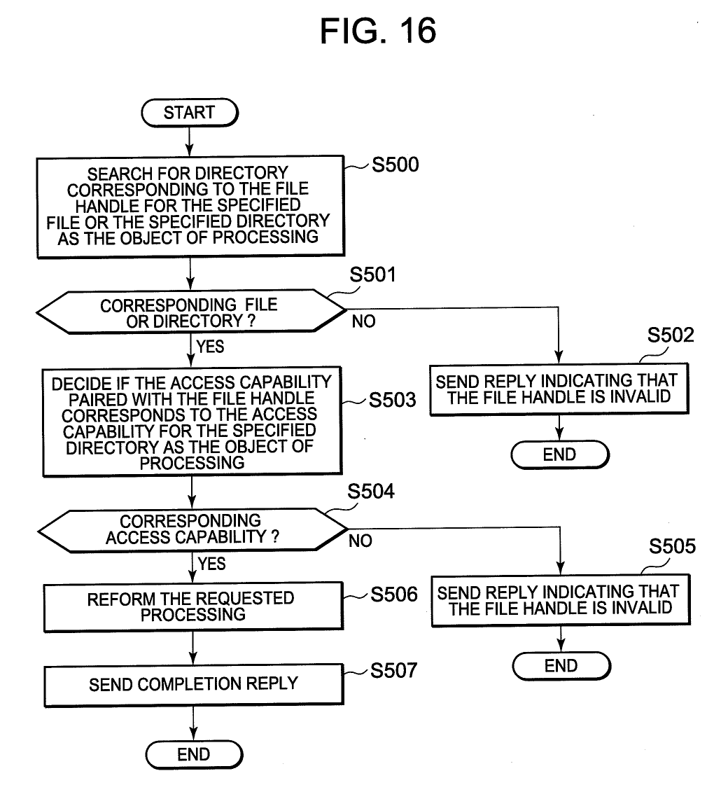

FIG. 16 is a flow chart showing an example of the operation when storage 1 receives metadata processing request. In this example, the metadata access processor 103a of metadata management unit 10a processes the metadata processing request.

As shown in FIG. 16, when the metadata access processor 103a receives a metadata processing request, specifying a file handle and an access capability for the directory or the file being the object of processing and parameter indicating the content of processing, from host 2, a file or a directory corresponding to the file handle and the access capability for the file or the directory that is the object of the processing, is searched in the metadata storage unit 11a (step S500).

If there is no corresponding directory, then the process shifts to step S502, and if there is a corresponding directory, then the process shifts to step S503 (step S501). In step S502, a reply indicating the file handle is invalid is returned (sent to host 2 being the source of request), and the process ends.

On the other hand, if information of the directory or the file (metadata) corresponding to the file handle for the directory or the file being the object of processing is stored in the metadata storage unit 11a, i.e. in step S503, the access capability decision unit 102 determines, within the metadata for the directory in the metadata storage unit 11a acquired in step S500, whether or not the access capability paired with the file handle for the directory corresponds to the access capability for the specified file or the specified directory as the object of processing. If there is a corresponding access capability then the process shifts to step S506, and if there is no corresponding capability then the process shifts to step S505 (step S504).

If the is no corresponding access capability, i.e. in step S505, the metadata processing request is not to be capable, and the metadata access processor 103a returns a reply indicating that the file handle is invalid, and the process ends. For example, when the file handle for the file or the directory being the object of processing is searched in the metadata storage unit 10a, the metadata access processor 103a may notify the access capability decision unit 102 of the file handle and information of the specified file or the specified directory as the object of processing and inquire whether the request is to be capable or not. Then, according to the response to the inquiry from the access capability decision unit 102, a reply indicating that the file handle is invalid may be returned.

On the other hand, when there is a corresponding access capability, i.e., in step S506, the metadata processing request is to be capable, and the metadata access processor 103a performs requested processing of the metadata for the specified file or the specified directory, according to the specified parameter. The requested processing is, for example, change of access authority and so on. Then, a completion reply is returned (step S507), and the process ends.

If a reply other than the completion reply is returned from storage 1, then the storage access unit 20 of host 2 may end the processing as an error (after returning a message indicating that processing of the metadata fails). If a reply indicating that the specified file handle is invalid is returned from storage 1, then the storage access unit 20 may re-perform the process from the pathname resolution.

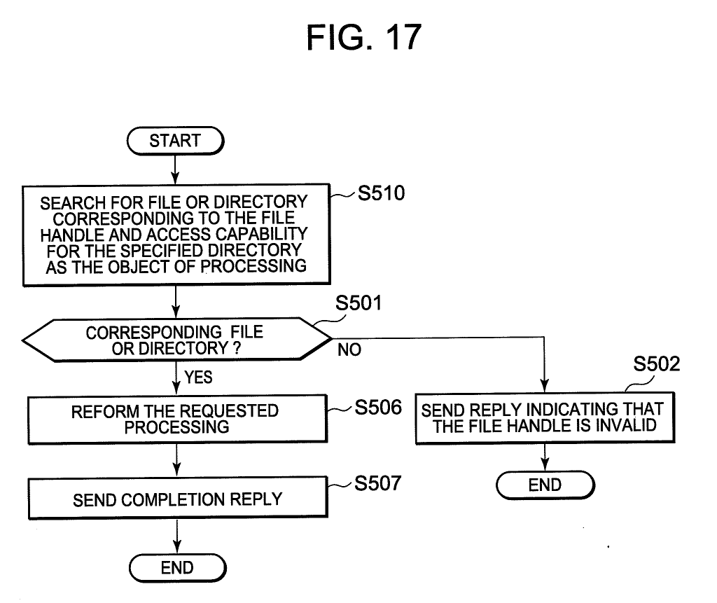

The value of file handle and the value of access capability can be judged together even in the operation when the metadata processing request is received. As shown in FIG. 17, for example, a match for both the file handle and the access capability for the upper-layer directory may be searched in metadata storage unit 10a (step S510). For example, the metadata access processor 103 may notify the access capability decision unit 102 of the received metadata processing request, and inquire whether the request is to be capable or not, and if there is a match as a result of the processing in step S510, the access capability decision unit 102 may return the response to the inquiry, indicating the metadata processing request is capable, along with the file handle for the upper-layer directory. Since the operation in and after step S511 is identical to the operation in and after step S504 in FIG. 16, the description is omitted.

The operation described above shows the example of a processing request for metadata, but when it comes to, for example, a processing request for file data (read/write processing, etc.), the process to judge whether the request is to be capable can be the same as above operation, although there is a difference that the request is processed not by the metadata access processor 103a but by the file data access processor 103b.

The process of access capability assignment executed by access capability assigning unit 101 is described next. When the file handle is specified and assignment of an access capability is requested, the access capability assigning unit 101 assigns an access capability distinguishable from a previous access capability having the same value.

As a method for above, such a method as storing the access capability, which is previously assigned, for each file handle, and assigning values different from these previous values can be adopted. The access capability which has had the largest value may be stored, and a value larger than the largest value may be assigned. The access capability that had the largest value assigned up to the time in the entire storage may be stored, and a value larger than the largest value may be assigned regardless of the file handle. Moreover, the access capability assigning unit 101 may include a calendar timer, and date and time, at the time of assignment, may be assigned as a access capability.

In this way, according to this exemplary embodiment, in a system including a file handle cache in a host, requests to a file or a directory other than the file or the directory targeted by the host, can be avoided. This is because an access capability that uniquely identifies the making of a file or a directory is assigned, and is held by file handle cache, wherein only the request of which file handle and access capability are the same in the storage is processed. For example, even if the name of the file or the value of the file handle are shared and each have the same value, since the access capability has different value, it can be avoided that host 2 processes a file or a directory other than the targeted file or the targeted directory.

Moreover, when processing is not performed, the host can be informed that the file handle is invalid so that a request to the storage for processing invalid file handle can be avoided on subsequent request, without periodical invalidation of file handle cache. In other words, the efficiency of file handle cache can be improved.

Further, by the judging process in storage, the process to a directory or a file other than the directory or the file targeted by the host 2 can be avoided, so it is not required that the entry of file handle cache is invalidated according to elapse of time in order to eliminate inconsistency between in the file handle cache and the information in the storage, and, therefore, the hit rate of the file handle cache is improved. In other words, the efficiency of file handle cache can be further improved.

When a reply indicating that the file handle cache is invalid is returned from the storage, the pathname resolution is re-performed so that the processing of the file or the directory specified by pathname can be performed if it (the file or the directory specified by the pathname) is. newly made. In other words, by access capability, not only processing to a file or a directory other than the targeted file or targeted directory can be avoided, but also processing to the targeted file or the targeted directory can be performed.

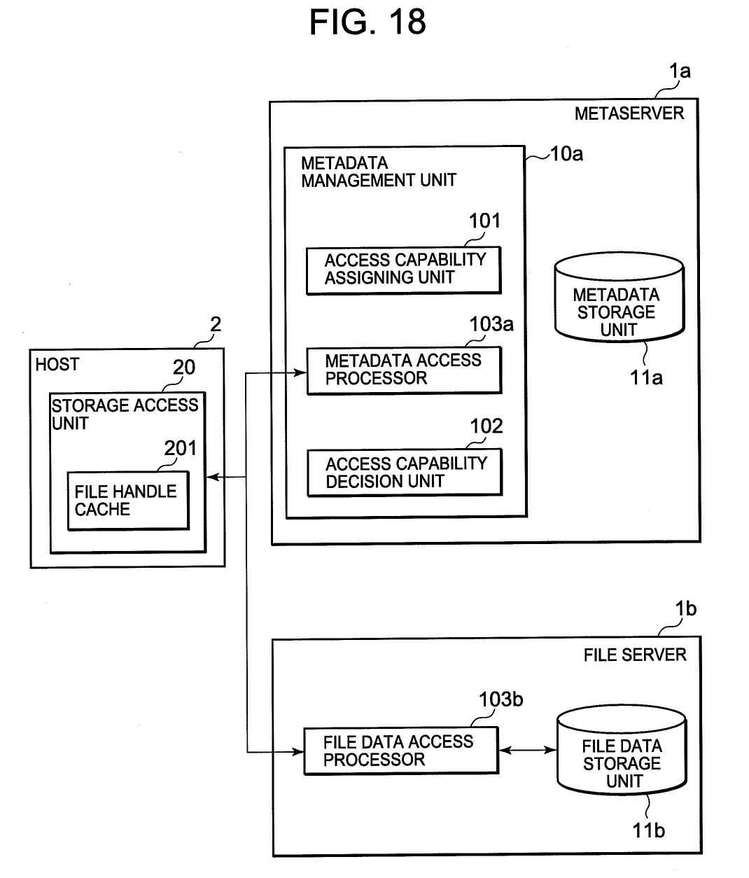

Here, a second exemplary embodiment is described. As shown in FIG. 18, storage 1 may include a metaserver 1a containing a metadata management unit 10a and a metadata storage unit 11a, and a file server 1b containing a file access processor 103b and a file data storage unit 11b. A multiple number of metaserver 1a and file server 1b may be included.

The file server 1b may also be a device which stores OSD (Object Based Storage Devices) object (object server or object device).

The metadata for the file in this exemplary embodiment is described next. If the storage 1 is configured by divided into a metaserver 1a and a file server 1b, then the metadata for the file includes attribute information of the file, an access capability, and information for accessing the file data of the file server 1b (information corresponding to the file handle). The information for accessing the file data may be, for example, concerning each data block within a file, information for accessing the file server 1b storing the data block (IP address, host name, and so on) and the offset address and the size of the corresponding data block in a file server 1b. If the file server 1b is an OSD, then the information may be information for accessing the object server storing each object configuring the file and an identifier for the corresponding object in the object server.

Concerning a request processed by the file server 1b such as reading and writing of file data, it may be possible that the access capability is not used. In this way, since the file server 1b is not required to communicate with metaserver 1a when it processes a request, the efficiency of processing is improved.

The third exemplary embodiment of this invention is described next. This exemplary embodiment is compatible with multi-generation storage 1 by snapshot or backup function. “Generation” here means a separation to regard information at each point (point along a time axis) where the snapshot or backup function is executed as a group of information.

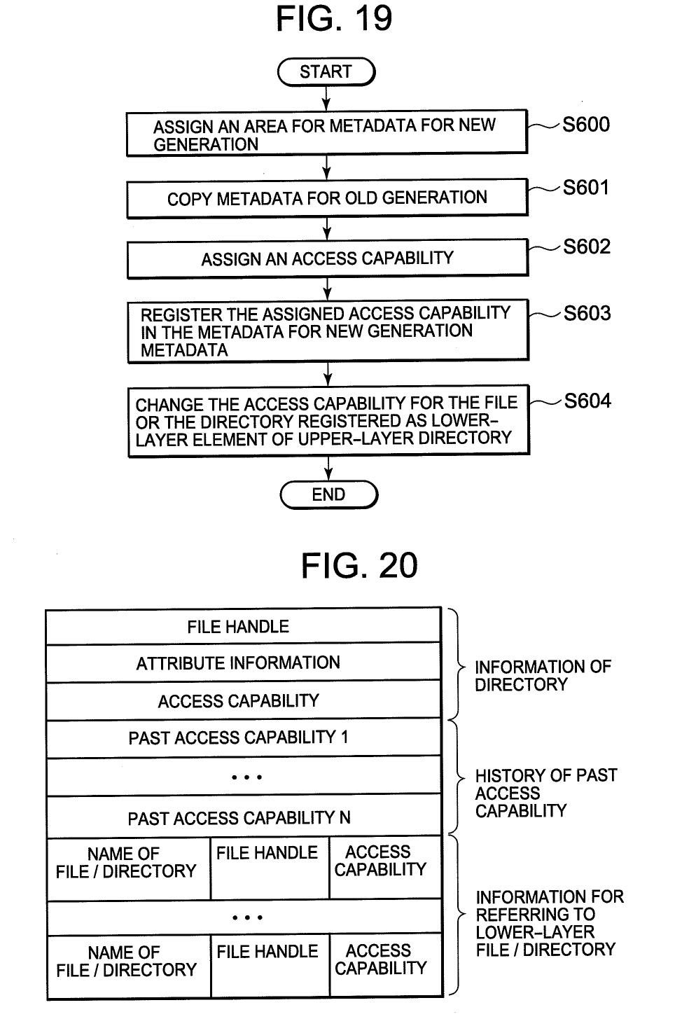

First, the processing to make a new generation for the file or directory is described next. FIG. 19 is a flow chart showing an example of the operation during making a new generation in this exemplary embodiment. The description for this exemplary embodiment uses the case where the access capability assigning unit 101 performs processing concerning metadata during making of a new generation as an example.

When a new generation for a file or a directory is made, the access capability assigning unit 101 retains a storage area in the metadata storage unit 11a for a file or a directory of newly made generation (step S600).

Next, metadata for an old generation file or an old generation directory is copied into metadata for a new generation file or a new generation directory that is obtained in step S600 (step S601). Then, the access capability assigning unit 101 assigns an access capability paired with the file handle for the new generation file or the new generation directory (step S602). The access capability assigned here has a value that is, of course, different from the access capability assigned as a pair with the old generation file handle.

The access capability assigned as a pair with the file handle for the new generation file or the new generation directory is next registered by overwriting it onto metadata for the file or the directory in the metadata storage unit 10a retained in step S600. In other words, the area where access capabilities registered as a pair with the file handle for the old generation file or the old generation directory, are changed to the value of access capability for new generation that is newly assigned.

Next, metadata for the upper-layer directory is searched in metadata storage unit 10a, and information of a file or a directory, for which a new generation is made, and which is registered as a lower-layer element in the metadata for upper-layer directory, are also changed to the newly assigned access capability (step S604).

In this way, an access capability different from a previous access capability is assigned for a file or directory for which new generation is made, to allow the upper-layer directory to refer to the new generation.

In this exemplary embodiment, when host 2 sends a processing request to storage 1, a plurality of files or directories for which file handle are the same might be found in metadata storage unit 10a. However, since there is only one file or directory for which access capability is the same, an access to a file or a directory other than the targeted file or the targeted directory is prevented.

In this way, a request to a file or a directory other than a file or a directory of which generation is targeted by host can be avoided even in system containing a file handle cache in the host utilizing multi-generation storage. The reason is that an access capability is changed according to generation and is held in the file handle cache, and only a request where both the file handle and the capability are the same in the storage is processed.

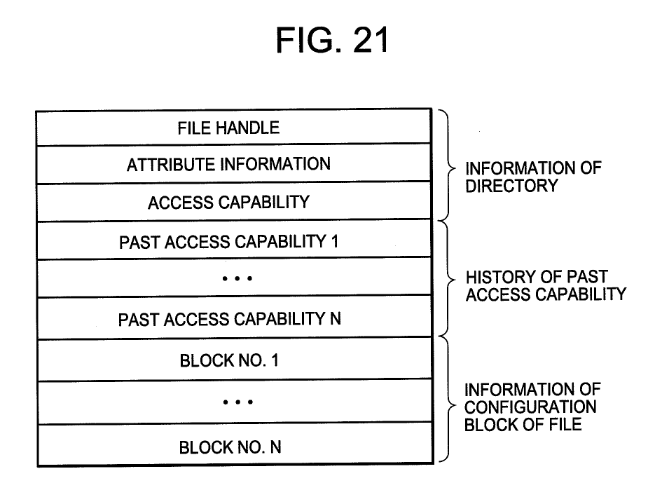

Further, when the storage is in a multi-generation form, the object of the access from host 2 to storage 1 can be specified with a latest generation form. In this case, when sending requests from host 2 to storage 1, along with the file handle and access capability, a flag indicating the latest generation may be attached. In the metadata managed in the storage 1, as shown in FIG. 20 or FIG. 21, an old generation access capability may be held as history information each time a new generation is made. For example, each time the generation changes and a new access capability is assigned, the metadata access processor 103a may retain a storage area for storing the access capability up to the time and copies the access capability up to the time into metadata for the new generation file or directory, and the access capability that used to be the latest generation up to the time is then added into the history information of the old generation access capability, then an access capability assigned for the new generation may be registered as the latest generation access capability.

In this way, the relation between generations can be recorded. Moreover, if the file handle has been shared, since metadata can be formed in a state possessing no past access capability, it can be determined whether or not there is a relation based on the past access capability even though the value of file handle is the same.

Moreover, in metadata, instead of registering the access capability separating into new generation and past, the access capability assigning unit 101 may assign an access capability in a form that allows it to determine which one is the latest one based on value, such as monotonically increasing value or the date (including time). The date (including time) that the access capability is assigned to the metadata may be recorded and it may be enabled to determine which generation is the latest.

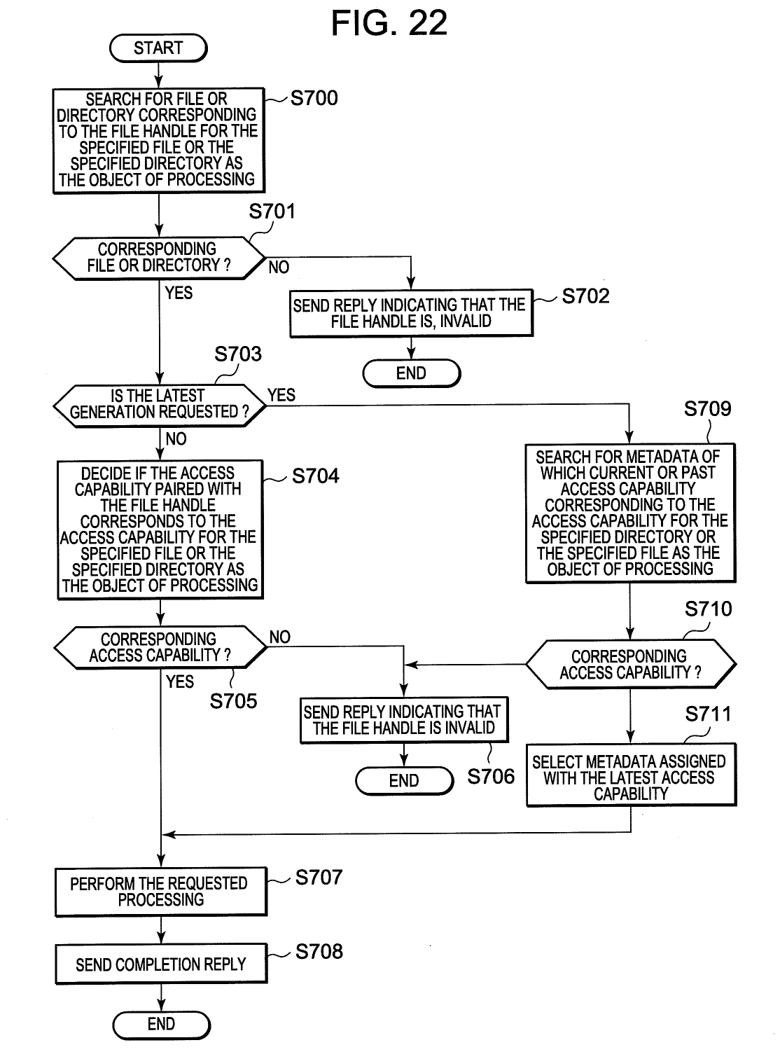

The processing of the storage 1 when receiving a request from host 2, according to this exemplary embodiment, is described next. FIG. 22 is a flow chart showing an example of the operation of storage 1, when a request from host 2 is received, according to this exemplary embodiment. In this exemplary embodiment, along with a file handle and an access capability for a file or a folder that is the object of the processing, a flag indicating whether or not a new generation is requested is to be specified by host 2. Besides, a parameter or the like indicating the content of the requested processing is specified. The case where a processing request relates to metadata is described next as an example. In this exemplary embodiment, the metadata access processor 103a processes the metadata processing request the host 2.

As shown in FIG. 22, for example, when the metadata access processor 103a receives an access capability and a file handle for a directory or a file being the object of processing, a flag indicating whether or not a new generation is requested from the host 2, and a processing request specifying a parameter indicating the content of processing, then a file or a directory for which file handle corresponds to the file handle for the directory or the file being the object of processing, is searched in metadata storage unit 11a (step S700).

If there is no corresponding file or directory then the process shifts to step S702, and if there is a corresponding file or directory then the process shifts to step S703 (step S701). In step S702, a reply indicating that the file handle is invalid is returned (sent to host 2 being the source of request), and the process ends.

On the other hand, when information of the file or the directory (metadata) corresponding to the file handle for the file or the directory being the object of processing is stored in the metadata storage unit 11a, i.e. in step S703, if the specified flag indicates that the latest generation is requested then the process shifts to step S709, otherwise the process shifts to S704. In step S704, the access capability decision unit 102 searches the metadata for file or directory within the metadata storage unit 11a acquired in step S700, for an access capability paired with the file handle for the file or the directory corresponding to the access capability for the specified directory or the specified file as the object of processing. If there is a corresponding access capability then the process shifts to step S707, and if there is no corresponding access capability then the process shifts to step S706 (step S705).

If the specified flag does not indicate a request for new a generation, and if the specified access capability does not correspond, i.e. in step S706, the metadata processing request is not to be capable, and the metadata access processor 103a returns a reply indicating that the file handle is invalid and the process ends. If the specified access capability is identical, i.e. in step S707, the metadata processing request is to be capable, the metadata access processor 103a may perform the requested process to the metadata for the specified file or the specified directory according to the specified parameter. Then, a completion reply is then returned (step S708), and the process ends.

On the other hand, when the specified flag indicates a request for the latest generation, i.e. in step S709, the access capability decision unit 102 searches the metadata for the file or directory within the metadata storage unit 11a acquired in step S700, for an access capability paired, at the moment or in past moment, with the file handle for the file or the directory corresponding to the access capability for the specified directory or the specified file as the object of processing. If there is a corresponding access capability then the process shifts to step S711, and if there is no corresponding access capability then the process shifts to step S706 (step S710).

In step S706, the metadata processing request is not to be capable, and the metadata access processor 103a returns a reply indicating that the file handle is invalid, and the process ends.

On the other hand, if the specified flag indicates a request for the latest generation, and if the specified access capability is identical, i.e. in step S711, the latest generation of metadata is selected among the metadata that is searched in step S709, and after setting the file handle indicated by the metadata as the file handle for the file or the directory being the object of processing, the process shifts to step S707. For example, if the access capability is assigned by utilizing the value that is monotonically increasing, then the metadata assigned with the largest value may be selected as metadata for the latest generation. Also, for example, if the date when the access capability is assigned is stored, then the metadata may be selected based on the date. Furthermore, for example, within metadata for upper-layer directory of file or directory being the object of processing, metadata containing an access capability registered as the lower-layer file or lower-layer directory may be selected.

If a reply other than a completion reply is returned from storage 1, then the storage access unit 20 may end the processing as an error (return a message indicating that processing of metadata failed.). If a reply indicating that the file handle specified by storage 1 is invalid is returned, then the storage access unit 20 may re-perform the process from the pathname resolution.

The operation described above shows the example of a processing request for metadata, but when it comes to, for example, a processing request for file data (read/write processing, etc.), the process to judge whether the request is to be capable and the process to acquire the file handle for the object of processing can be the same as above operation, although there is a difference that the request is processed not by the metadata access processor 103a but by the file data access processor 103b.

In this way, the latest generation of the targeted file or the targeted directory can be accessed in a multi-generation storage.

In above exemplary embodiments, the structure of storage including an access processor configured to access data according to an access request specifying a file or a directory as an object of processing according to a content of a file handle cache held in a source of the request, further including an access capability assigning unit configured to assign, when a file or a directory is made, an access capability serving as an identifier for uniquely identifying the file or the directory, and store the assigned access capability paired with a file handle for the file or the directory as metadata for the file or the directory and an access capability decision unit configured to decide, for the access request received by the access processor, whether the file handle specified as the object of processing of the access request is valid or invalid, based on a combination of the file handle and the access capability, wherein the access processor returns the access capability along with the file handle paired with the access capability according to a file handle acquisition request. In this exemplary embodiment, capability assignment unit is realized by the access capability assigning unit 101. The access capability assignment unit is realized by the access capability decision unit 102 is shown. The access processor is realized by the access processor 103.

In above exemplary embodiments, the structure of storage where the access capability decision unit determines that the file handle specified as the object of processing of the access request is valid when the combination of the file handle and the access capability included in the access request is identical with the combination of the file handle and the access capability stored as metadata is shown (See, for example, access capability decision unit 102 of the first exemplary embodiment.).

Also, in above exemplary embodiments, the structure of storage where the access capability assigning unit assigns, when making a new generation of the file or the directory, the access capability for uniquely identifying the new generation of the file or the directory, and stores the access capability paired with the file handle for the file or the directory as metadata for the new generation of the file or the directory is shown (See, for example, access capability decision unit 102 of the third exemplary embodiment, and FIG. 19.).

Also, in above exemplary embodiments, the structure of storage where the access capability assigning unit also stores the history of the access capability assigned to the old generation of the file or the directory as metadata for the new generation of the file or the directory is shown (See, for example, access capability assigning unit 101 of the third exemplary embodiment, and FIG. 19 and FIG. 20.).

Also, in above exemplary embodiments, the structure of storage where the access capability decision unit determines, when the latest generation of the file or the directory is specified as the object of processing of the access request, that the file handle specified as the object of processing of the access request is valid when the combination of the file handle and the access capability included in the access request is identical with the combination of the file handle and the access capability for the latest generation stored as metadata or the combination of the file handle and the access capability for the old generation, and sets the latest generation of the file or the directory as the object of processing is shown (See, for example, access capability decision unit 102 of the third exemplary embodiment, and FIG. 22.).

Also, in above exemplary embodiments, the structure of storage includes a metaserver including a metadata storage unit configured to store metadata, and a first access processor configured to access metadata according to the access request for the metadata, and a file server including a file data storage unit configured to store file data, and a second access processor configured to file data according to the access request for the file data, wherein the metaserver includes the access capability assigning unit, and the access capability decision unit is shown. (See, for example, the second exemplary embodiment.). Also in above exemplary embodiments, the structure of storage where the second access processor accesses the file data according to the received access request for the file data without the decision of the access capability decision unit. In the above exemplary embodiments, the first access processor is realized by the metadata access processor 103a. And, the second access processor is realized by the file data access processor 103b.

Also, in above exemplary embodiments, the structure of computer system includes a host computer that operates according to a user program, and a storage that accesses data according to an access request specifying a file or a directory as an object of processing according to a content of a file handle cache held in the host computer, wherein the storage includes an access processor configured to receive the access request from the host computer, and access the data according to the received access request, an access capability assigning unit configured to assign, when a file or a directory is made, an access capability serving as an identifier for uniquely identifying the file or the directory, and store the assigned access capability paired with a file handle for the file or the directory as metadata for the file or directory, and an access capability decision unit configured to decide, for the access request received by the access processor, whether the file handle specified as the object of processing of the access request is valid or invalid, based on a combination of the file handle and the access capability, wherein the access processor returns the access capability along with the file handle paired with the access capability according to a file handle acquisition request; and wherein the host computer include a storage device configured to store the file handle returned according to the file handle acquisition request as a pair with access capability, as the file handle cache, and a storage access unit configured to send an access request specifying information of the pair of the file handle and the access capability stored as the file handle cache, to the storage, as information for specifying the file or the directory as the object of processing. In the exemplary embodiments, the storage device of the host computer is realized by a file handle cache 201. The storage access unit is realized by a storage access unit 20.

According to each exemplary embodiment described above, an improvement of storage accessing performance can be achieved.

This invention may apply to any system utilizing a storage configured to access data according to an access request where the object of processing is specified by a file handle held in the host.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A storage comprising:
an access processor configured to access data according to an access request specifying a file or a directory as an object of processing according to a content of a file handle cache held in a source of the request;
an access capability assigning unit configured to assign, when a file or a directory is made, an access capability serving as an identifier for uniquely identifying the file or the directory, and store the assigned access capability paired with a file handle for the file or the directory as metadata for the file or the directory; and
an access capability decision unit configured to decide, for the access request received by the access processor, whether the file handle specified as the object of processing of the access request is valid or invalid, based on a combination of the file handle and the access capability,
wherein the access processor returns the access capability along with the file handle paired with the access capability.

2. The storage according to claim 1, wherein the access capability decision unit determines that the file handle specified as the object of processing of the access request is valid when the combination of the file handle and the access capability included in the access request is identical with the combination of the file handle and the access capability stored as metadata.

3. The storage according to claim 1, wherein the access capability assigning unit assigns, when making a new generation of the file or the directory, the access capability for uniquely identifying the new generation of the file or the directory, and stores the access capability paired with the file handle for the file or the directory as metadata for the new generation of the file or the directory.

4. The storage according to claim 3, wherein the access capability assigning unit also stores the history of the access capability assigned to the old generation of the file or the directory as metadata for the new generation of the file or the directory.

5. The storage according to claim 4, wherein the access capability decision unit determines, when the latest generation of the file or the directory is specified as the object of processing of the access request, that the file handle specified as the object of processing of the access request is valid when the combination of the file handle and the access capability included in the access request is identical with the combination of the file handle and the access capability for the latest generation stored as metadata or the combination of the file handle and the access capability for the old generation, and sets the latest generation of the file or the directory as the object of processing.

6. The storage according to claim 1, further comprising:
a metaserver including a metadata storage unit configured to store metadata, and a first access processor configured to access metadata according to the access request for the metadata; and
a file server including a file data storage unit configured to store file data, and a second access processor configured to file data according to the access request for the file data,
wherein the metaserver includes the access capability assigning unit, and the access capability decision unit.

7. The storage according to claim 6, wherein the second access processor accesses the file data according to the received access request for the file data without the decision of the access capability decision unit.

8. A computer system comprising a host computer that operates according to a user program, and a storage that accesses data according to an access request specifying a file or a directory as an object of processing according to a content of a file handle cache held in the host computer,
wherein the storage comprises:
an access processor configured to receive the access request from the host computer, and access the data according to the received access request;
an access capability assigning unit configured to assign, when a file or a directory is made, an access capability serving as an identifier for uniquely identifying the file or the directory, and store the assigned access capability paired with a file handle for the file or the directory as metadata for the file or directory; and
an access capability decision unit configured to decide, for the access request received by the access processor, whether the file handle specified as the object of processing of the access request is valid or invalid, based on a combination of the file handle and the access capability,
wherein the access processor returns the access capability along with the file handle paired with the access capability; and
wherein the host computer comprises:
a storage device configured to store the file handle returned according to the file handle acquisition request as a pair with access capability, as the file handle cache; and
a storage access unit configured to send an access request specifying information of the pair of the file handle and the access capability stored as the file handle cache, to the storage, as information for specifying the file or the directory as the object of processing.

9. The computer system according to claim 8, wherein the storage access unit discards the file handle cache storing the specified file handle and access capability as a pair, when a reply, for the access request, indicating that the specified file handle is invalid is received from the storage.

10. The computer system according to claim 8, wherein the storage access unit executes the pathname resolution process for the file or the directory corresponding to the specified file handle, when a reply, for the access request, indicating that the specified file handle is invalid is received from the storage.

11. An access control method used in a storage configured to access data according to an access request specifying a file or a directory as an object of processing according to a content of a file handle cache held in a source of the request, comprising:
assigning, when a file or a directory is made, an access capability serving as an identifier for uniquely identifying the file or the directory, and storing the assigned access capability paired with a file handle for the file or the directory as metadata for the file or the directory;
returning the access capability along with the file handle paired with the access capability according to the file handle acquisition request;
determining, for the received access request, whether the file handle specified as the object of processing of the access request is valid or invalid, based on a combination of the file handle and the access capability; and
accessing data according to the access request when it is determined that the file handle specified as the object of processing is valid.

12. The access control method according to claim 11, wherein it is determined that the file handle specified as the object of processing of the access request is valid when the combination of the file handle and the access capability included in the access request is identical with the combination of the file handle and the access capability set stored as metadata.

13. The access control method according to claim 11, further comprising:
assigning, when making a new generation of the file or the directory, the access capability for uniquely identifying the new generation of the file or the directory, and
storing the access capability paired with the file handle for the file or the directory as metadata for the file or the directory.

14. A control program used in a storage configured to access data according to an access request specifying a file or a directory as an object for processing according to a content of a file handle cache held in a source of the request, comprising:
a process for assigning, when a file or a directory is made, an access capability serving as an identifier for uniquely identifying the file or the directory, and storing the assigned access capability paired with a file handle for the file or the directory as metadata for the file or the directory;
a process for returning the access capability along with the file handle paired with the access capability according to the file handle acquisition request;
a process for determining, for the received access request, whether the file handle specified as the object of processing of the access request is valid or invalid, based on a combination of the file handle and the access capability; and
a process for accessing data according to the access request when it is determined that the file handle specified as the object of processing is valid.

15. The control program according to claim 14, wherein it is determined that the file handle specified as the object of processing of the access request is valid when the combination of the file handle and the access capability included in the access request is identical with the combination of the file handle and the access capability set stored as metadata.

16. The control program according to claim 14, further comprising:
the process for assigning, when making a new generation of the file or the directory, the access capability for uniquely identifying the new generation of the file or the directory, and
storing the access capability paired with the file handle for the file or the directory as metadata for the file or the directory.
